(19) United States
(12) Patent Application Publication
(10) Pub. No.: US 2025/0187804 A1
(43) Pub. Date: Jun. 12, 2025

(54) LIQUID STORAGE CONTAINER

(71) Applicant: CANON KABUSHIKI KAISHA, Tokyo (JP)

(72) Inventors: SHIGEKI FUKUI, Kanagawa (JP); HITOSHI TAKADA, Kanagawa (JP); HIROKI HAYASHI, Kanagawa (JP)

(21) Appl. No.: 18/964,765

(22) Filed: Dec. 2, 2024

(30) Foreign Application Priority Data
Dec. 7, 2023 (JP) 2023-206730

(51) Int. Cl. B65D 65/38; B41J 2/175

(52) U.S. Cl. CPC B65D 65/38; B41J 2/17536; B65D 2565/384

(57) ABSTRACT

A liquid storage container has a storage unit storing liquid, a supply unit for externally supplying liquid stored in the storage unit, and a protective member protecting the supply unit. The protective member contains a recycled plastic material or a resin material obtained by mixing recycled plastic materials. The protective member has such a portion that while the protective member is attached to the supply unit, a relationship between a side surface width A of the protective member on a first end side and a side surface width B of the protective member on a side of the storage unit opposite to the first end side satisfies 1<A/B<7.

### BACKGROUND OF THE INVENTION

### Field of the Invention

The present disclosure relates to a liquid storage container capable of storing liquid such as ink.

### Description of the Related Art

From the viewpoint of environmental friendliness, products using a recycled plastic material are manufactured. In general, the use of a recycled plastic material for molding has a problem that the impact absorbency is impaired at the time of drop/collision of a recycled plastic material molded article. The influence is large especially in a case where a recycled plastic material is used for a large-capacity liquid storage container of an inkjet printing apparatus (liquid ejection apparatus).

The recycled plastic material is made from materials that have been deteriorated to no small extent by a thermal history during molding, a stress, heat, light, and solvent during use, and the like. In view of the circumstances, it is known that the recycled plastic material is different in physical property from a virgin material. For example, the recycled plastic material tends to be low in impact absorbency, which is the ability of molecular chains in the material to warp and relieve force in a case where an impact is applied. This tendency can be confirmed by the Charpy impact test; a molding material including the recycled plastic material exhibits impact strength lower than that of a virgin material. Such impairment of the impact absorbency is caused because the original molecular chains have been broken by the aforementioned deterioration and the impact absorbing effect of the molecular chains has decreased.

Japanese Patent Laid-Open No. H10-16249 (1998) (hereinafter referred to as document 1) shows a configuration for giving sufficient rigidity to an ink cartridge body molded from a soft synthetic resin material. More specifically, ridges are provided at the corners of the peripheral wall of the ink cartridge body and an opening end edge is made thick, while protrusions are provided in a longitudinal direction on the inner surface of a lid body and protruding portions are molded to protrude.

As stated above, in a case where a recycled plastic material is used as a material for a liquid storage container, the impact strength tends to be lower than that of a virgin material. In particular, in a case where a protruding portion is provided at the end of a liquid storage container as shown in document 1, if the container is mistakenly dropped and the protruding portion directly receives an impact, the protruding portion at the end may be chipped or cracked.

### SUMMARY OF THE INVENTION

A liquid storage container according to an aspect of this disclosure includes a storage unit configured to store liquid, a supply unit configured to externally supply liquid stored in the storage unit, and a protective member configured to protect the supply unit, wherein the protective member contains a recycled plastic material or a resin material obtained by mixing recycled plastic materials, and the protective member has such a portion that while the protective member is attached to the supply unit, a relationship between a side surface width A of the protective member on a first end side and a side surface width B of the protective member on a side of the storage unit opposite to the first end side satisfies 1<A/B<7.

Further features of the present invention will become apparent from the following description of exemplary embodiments with reference to the attached drawings.

### BRIEF DESCRIPTION OF THE DRAWINGS

FIG. 1 is a perspective view of an inkjet printing apparatus;

FIG. 2 is a perspective view showing an ink tank;

FIG. 3 is a perspective view of a tank cover;

FIG. 4 is a perspective view of the tank cover;

FIG. 5 is a cross-sectional view of the tank cover;

FIG. 6 is a perspective view of the ink tank;

FIG. 7 is a perspective view of the tank cover;

FIG. 8 is a perspective view of the tank cover;

FIG. 9 is a cross-sectional view of the tank cover; and

FIG. 10 is a perspective view of the ink tank.

### DESCRIPTION OF THE EMBODIMENTS

Preferred embodiments of the present disclosure will be described below in detail with reference to the accompanying drawings. It should be noted that the following embodiments do not limit the matters disclosed herein and not all combinations of features described in the following embodiments are necessarily essential for solving a problem of this disclosure. The same constituent element is denoted by the same reference number. As the use of a liquid storage container, the refilling of liquid (ink) into a liquid ejection apparatus (inkjet printing apparatus) is described herein as an example. However, the use of the liquid storage container is not limited to this. Further, liquid stored in the liquid storage container is not limited to ink and may be, for example, predetermined processing liquid.

### First Embodiment

A recycled plastic material described in the present embodiment is used as abroad meaning including both a Post-Consumer Recycled material (PCR material) and a pre-consumer recycled material. The post-consumer recycled material (PCR material) is a material obtained by collecting and reusing plastic products distributed to the market. For example, the PCR material is a plastic prepared from cleaned and crushed waste products. The PCR material may be a thermoplastic prepared by a processor other than the first processor from industrial plastic wastes. The pre-consumer recycled material is a material obtained by collecting and reusing plastic wastes produced during a manufacturing process before distribution to the market. For example, the pre-consumer recycled material is a thermoplastic prepared from, after processing such as molding and extrusion in a processor's factory, offcuts resulting from reprocessing in the same factory or rejected molded articles. In the present embodiment, the recycled plastic material may be the PCR material, the pre-consumer recycled material, or a mixture thereof.

In the present embodiment, a recycled plastic material can be used after determination whether the recycled plastic material is suitable for use based on a size of contaminants. For example, a thin sample plate is molded and, in a case where a size of contaminants on the surface of the plate is less than a predetermined value, the material is determined to be a recycled plastic material suitable for use. For example, the predetermined value is assumed to be 1 mm². It should be noted that this value is an example and the predetermined value is not limited to this.

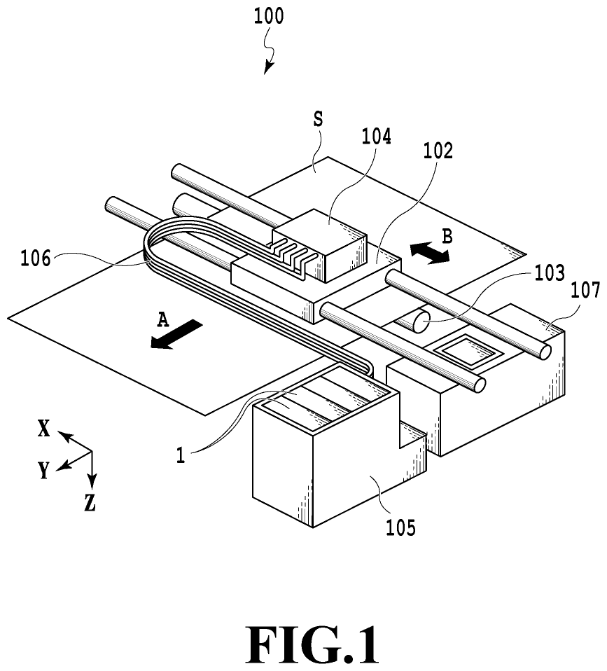

FIG. 1 is a perspective view of an inkjet printing apparatus 100, which is a liquid ejection apparatus using a liquid supply system in the present embodiment. In FIG. 1, the inkjet printing apparatus 100 is configured to eject ink from a print head 104 to a print medium S based on image data and print an image (including a character, symbol, etc.). The print head 104 is mounted on the carriage 102. In print operation, the print medium S is conveyed by a conveyance roller 103 in a conveyance direction (sub-scanning direction) shown by arrow A and the carriage 102 is moved reciprocally in a direction (main scanning direction) shown by arrow B intersecting the sub-scanning direction. The print head 104 is driven based on image data in synchronization with the movement of the carriage 102, whereby ink is ejected from the print head 104 to the print medium S. The print medium S is conveyed by the conveyance roller 107 by a predetermine pitch. The entire print medium is printed by alternately repeating conveyance by the predetermine pitch and printing corresponding to one line. As the print medium S, various materials described above can be used and a sheet such as print paper or a plastic sheet is generally used.

An ejection surface of the print head 104 facing the print medium S has an ejection opening array formed by a plurality of ejection openings arranged in series in the sub-scanning direction. A plurality of ejection opening arrays are provided to correspond to the number of types of ink for use. In color printing or gray-scale printing, a desired image is formed by ejecting different types of ink from the respective ejection opening arrays. Ink is supplied to the print head 104 from an ink supply unit 105, on which a plurality of ink tanks 1 corresponding to the respective ink colors are detachably mounted, through ink supply paths 106 such as tubes. Although FIG. 1 shows an example in which the ink tanks 1 are mounted for the four colors, the example of the mounted ink tanks 1 is not limited to this and the number of colors may be three or less, five or more, or one. Further, the ink tank 1 may be configured to store liquid other than ink.

The inkjet printing apparatus 100 of the present embodiment is a so-called serial scanning type printer. As described above, the print head 104 scans in the X direction (main scanning direction) orthogonal to the Y direction (conveyance direction) in which the print medium S is conveyed to print an image. However, the inkjet printing apparatus may be an apparatus having a so-called line type print head in which ejection openings extend in a width direction (X direction) of the print medium S.

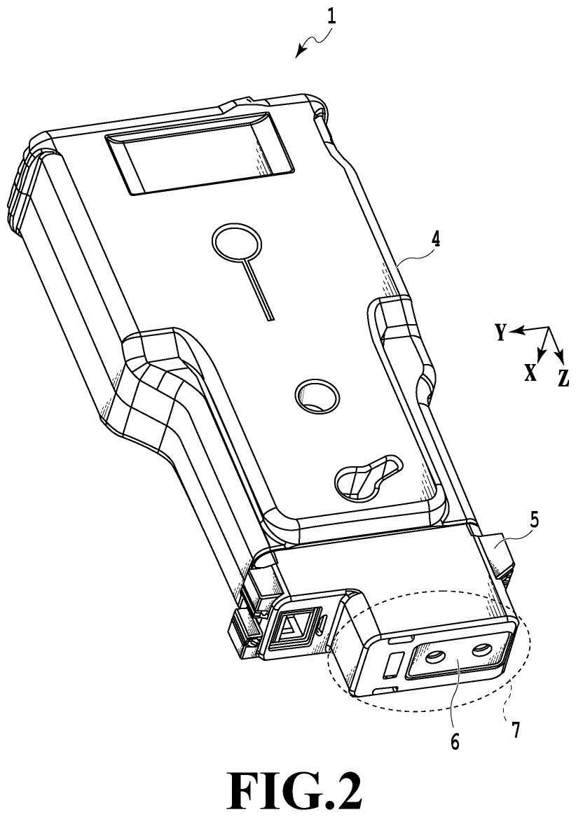

FIG. 2 is a perspective view showing the ink tank 1 according to the present embodiment. The ink tank 1 which is a liquid storage container stores, as liquid, pigment ink of a color in compliance with the configuration of the printing apparatus (such as black, cyan, magenta, or yellow). The ink tank 1 comprises a tank casing 4 and a tank cover 5. FIG. 2 shows a state in which the tank cover 5 is attached to the ink tank 1. The tank casing 4 of the ink tank 1 is molded by injection blowing or the like using a virgin material resin such as a polypropylene material (PP material) or a polyethylene material (PE material). The constituent elements of the ink tank 1 are assembled by techniques such as ultrasonic welding, thermal welding, bonding, or fitting.

The tank casing 4 directly functions as an ink storage unit. The ink tank 1 of the present embodiment has an ink storage capacity of about 300 ml. The tank casing 4 has a substantially rectangular prism shape. In the tank casing 4, a surface shown in FIG. 1 (a surface on the −X direction side; hereinafter defined as a front surface) and a surface opposite thereto (a surface on the +X direction side; hereinafter defined as a back surface) have the largest area in the rectangular prism shape. The ink tank 1 of the present embodiment is configured to be attached to and detached from an unshown fixed place in the inkjet printing apparatus 100.

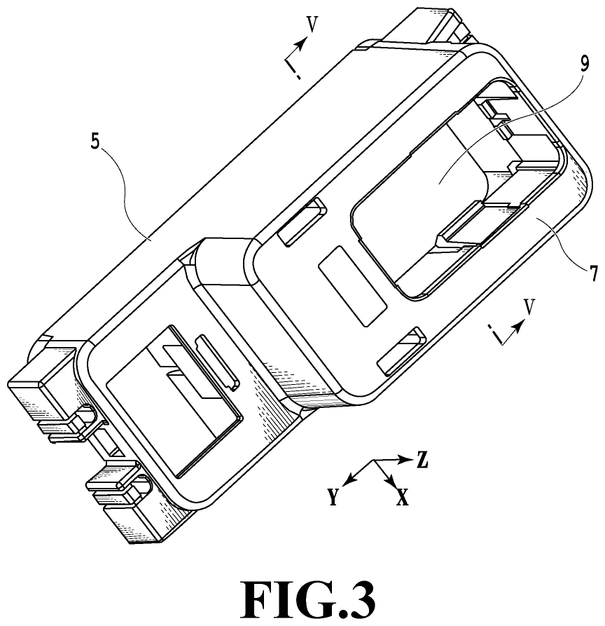

The tank cover 5 has an opening 9 (see FIG. 3 described later) such that a connection port 6 to the inkjet printing apparatus 100 is provided in the opening 9. While the ink tank 1 is mounted on the inkjet printing apparatus 100, ink stored in the ink tank 1 is supplied to the inkjet printing apparatus 100 through the connection port 6. That is, the ink tank 1 has a supply unit (connection port 6) which supplies stored liquid.

The tank cover 5 serves a function of protecting functional portions such as the connection port 6 from an external impact. That is, the tank cover 5 is a protective member which protects the ink tank 1. A side of the tank cover 5 provided with the connection port 6 to the inkjet printing apparatus 100 (a side shown by a broken line; the +Z direction side) is referred to as a first end side 7 (end side) of the tank cover 5. On the other hand, the tank casing 4 side of the tank cover 5 (the storage unit side opposite to the first end side 7; the −Z direction side) is also referred to as a second end side 8 (opposite end side). While the tank cover 5 is mounted on the ink tank 1, the first end side 7 (end side) of the tank cover 5 is protruding as compared with the other portion. Thus, for example, in a case where a user mistakenly drops the ink tank 1 and the first end side 7 directly receives an impact, the protruding portion may be chipped or cracked.

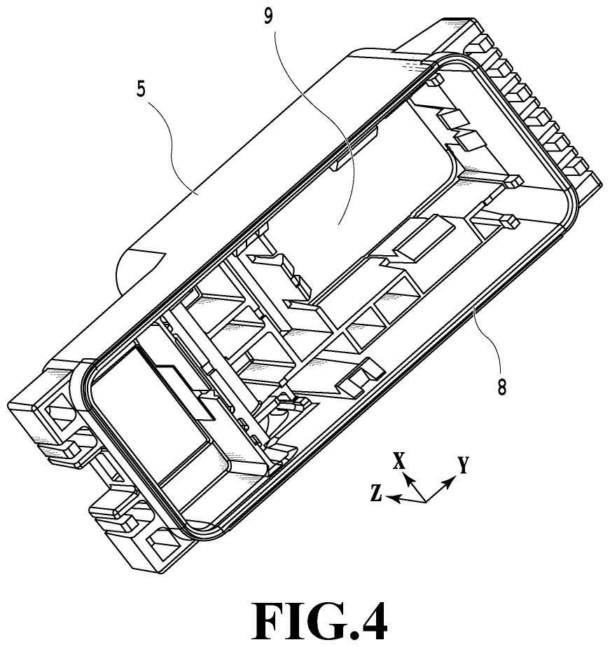

FIGS. 3 and 4 are perspective views of the tank cover 5. FIG. 3 is a perspective view of the entire ink tank 1 seen from the end side (that is, the first end side 7). FIG. 4 is a perspective view seen from the tank casing 4 side (that is, the second end side 8). The tank cover 5 has the opening 9 in which the connection port 6 is provided.

The tank cover 5 contains a recycled plastic material or a resin material obtained by mixing recycled plastic materials. The tank cover 5 of the present embodiment is formed using a PCR material obtained by recycling a PE material, a PP material, or the like. However, the material is not limited to this and may be another resin material or a plurality of materials. That is, a PP material, a PE material, or a mixture of different materials may be used as the recycled plastic material. As the physical property values of the PCR material used for the tank cover 5 of the present embodiment, the PE material has a Charpy impact value between about 4 kJ/m² and about 9 kJ/m² inclusive, an MFR value between about 8 g/10 min and about 13 g/10 min inclusive, and a flexural modulus between about 700 MPa and about 1,200 MPa inclusive. A virgin material has a Charpy impact value between about 3 kJ/m² and about 4 kJ/m² inclusive. Although the Charpy impact value of the PCR material may be generally less than that of the virgin material, it is preferable that the Charpy impact value of the PCR material be greater than that of the virgin material as in the present embodiment. The PP material has a Charpy impact value of 5 kJ/m² or more, an MFR value between about 35 g/10 min and about 40 g/10 min inclusive, and a flexural modulus of 1,000 MPa or more.

Incidentally, the physical properties of the PCR material may vary according to the physical properties of its resources and other coloring materials or additives. Accordingly, the Charpy impact value of the PCR material used in the present embodiment is greater than that of the virgin material. Incidentally, the Charpy impact value of the PCR material should preferably be greater than the Charpy impact value of the virgin material but does not necessarily have to be greater than the Charpy impact value of the virgin material.

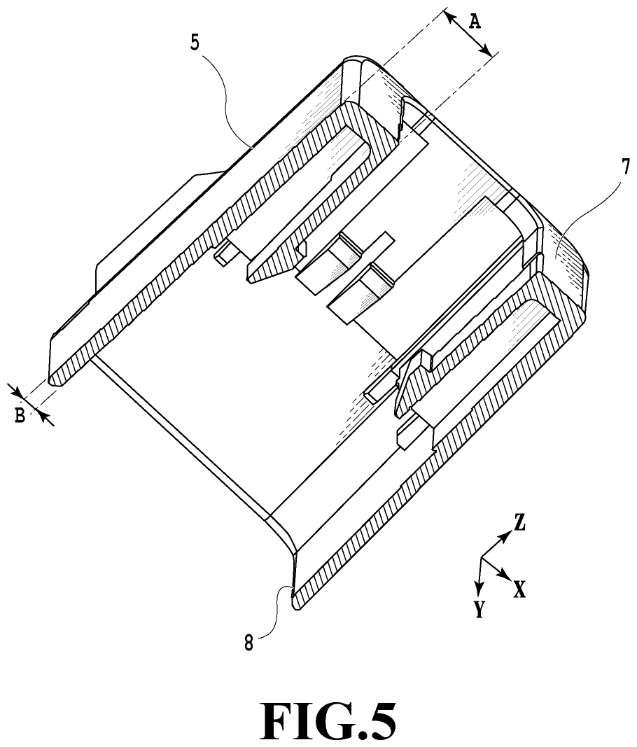

FIG. 5 is a cross-sectional view of the tank cover 5 showing V cross section in FIG. 3. The V cross section is a cross section extending across the tank cover 5 to intersect with (orthogonal to) the opening 9 in which the connection port 6 is provided. As shown in FIGS. 3 to 5, the tank cover 5 includes the first end side 7 and the second end side 8 positioned on the tank casing 4 side opposite to the first end side 7. As shown in FIG. 5, also in the V cross section, the tank cover 5 has a side surface width A on the first end side 7 and a side surface width B on the second end side 8.

In FIG. 5, a dimension of the side surface width A on the first end side 7 is about 6.0 mm. On the other hand, a dimension of the side surface width B on the second end side 8 is about 1.2 mm. As described above, the protruding portion of the first end side 7 of the tank cover 5 (the portion provided with the opening) may be chipped or cracked by being dropped. Thus, in the tank cover 5 of the present embodiment, a ratio of the side surface width A dimension on the first end side 7 (end side) to a basic thickness which is the side surface width B dimension on the second end side 8 (opposite end side) is

$$5 = A / B .$$

By increasing the width of the A dimension beyond the basic thickness, chipping or cracking by dropping can be reduced. The basic thickness is a thickness of a portion occupying the majority of the molded component. In the tank cover 5 of the present embodiment, as shown in FIGS. 3 to 5, the ratio of the second end side 8 is greater than the ratio of the first end side 7. Accordingly, the width B dimension on the second end side 8 (opposite end side) is defined as the basic thickness. Here, energy necessary for chipping or cracking by an impact is proportional to the width and thickness of the molded article. That is, in order to reduce chipping or cracking, an increase in width or thickness is considered. On the other hand, simply increasing the thickness of the molded article incurs the possibility of occurrence of a sink mark. In the present embodiment, the thickness on the first end side 7 is greater than the basic thickness, while the basic thickness is set at a predetermined thickness to the extent that a sink mark does not occur. By thus increasing the width of the A dimension beyond the basic thickness, chipping or cracking by dropping can be reduced.

Incidentally, the first end side 7 has the opening 9 in which the connection port 6 is provided. As shown in FIG. 3, the first end side 7 has side surface widths of different sizes other than the side surface width obtained in the cross-section V shown in FIG. 3. In the present embodiment, chipping or cracking by dropping can be reduced by setting a ratio of at least one side surface width A on the first end side 7 to the basic thickness which is the side surface width B dimension on the second end side 8 at 5=A/B.

Further, from the viewpoint of reduction of plastic members, a back surface of the side surface width A dimension on the first end side 7 may have a lightening hole. Here, in the completed shape of the ink tank 1 in FIG. 2, a surface visible from outside is defined as a front surface and a surface invisible from outside is defined as a back surface. In FIG. 5, a portion shown by arrow A may also have a lightening hole.

Further, although the opening 9 is provided in the first end side 7 in the tank cover 5 of the present embodiment, the opening 9 does not necessarily have to be provided. In the completed form of the ink tank 1 with the tank cover 5 mounted on the tank casing 4, chipping or cracking of the tank cover 5 by dropping can be reduced by increasing the width dimension on the first end side 7 beyond the basic thickness of the tank cover 5 as described above.

Incidentally, the A dimension and B dimension described above specify a relationship (A/B) between the side surface width on the first end side 7 and the side surface width on the second end side 8 in the same cross section (V cross section) corresponding to a plane intersecting with (orthogonal to) the opening of the first end side 7.

The A/B ratio in the present embodiment can largely increase the impact strength of the tank cover 5. Incidentally, it is known that chipping or cracking by drop/impact can be reduced as long as the PCR material PE has the following physical property values: a Charpy impact value of 4 kJ/m² or more, an MFR value between about 1 g/10 min and about 15 g/10 min inclusive, and a flexural modulus between about 500 MPa and about 1,500 MPa inclusive. It is known that chipping or cracking by drop/impact can be reduced as long as the PCR material PP has the following physical property values: a Charpy impact value of 3 kJ/m² or more, an MFR value between about 30 g/10 min and about 50 g/10 min inclusive, and a flexural modulus of 800 MPa or more.

As described above, according to the present embodiment, high impact strength can be maintained even in a case where the recycled plastic material is used for the liquid storage container. Accordingly, for example, even in a case where the liquid storage container is mistakenly dropped, chipping or cracking can be reduced.

### Second Embodiment

In the second embodiment, an ink tank of a type different from the first embodiment will be described. A recycled plastic material is used also in the ink tank which is a liquid storage container described in the present embodiment.

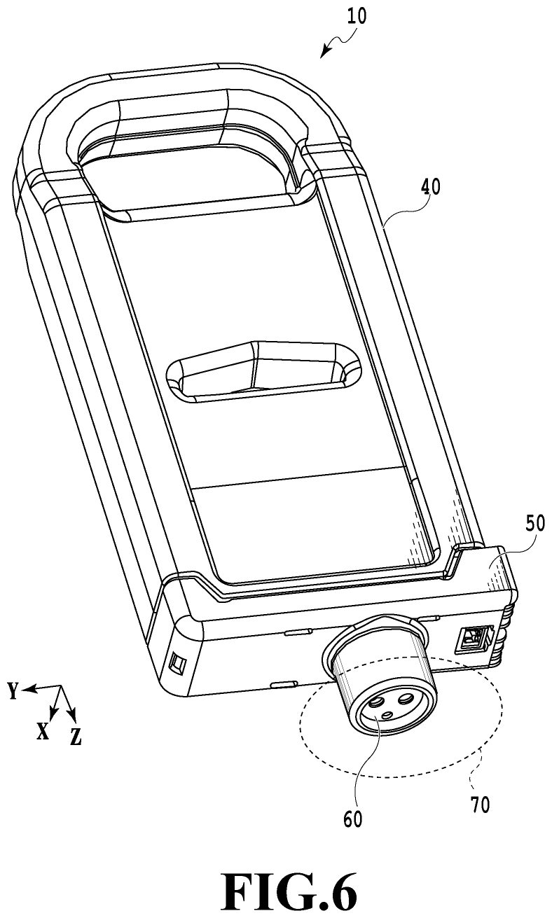

FIG. 6 is a perspective view of an ink tank 10 in the present embodiment. The ink tank 10 which is a liquid storage container stores, as liquid, pigment ink of a color in compliance with the configuration of the printing apparatus (such as black, cyan, magenta, or yellow). The ink tank 10 comprises a tank casing 40 and a tank cover 50. The tank casing 40 directly functions as an ink storage unit. In the present embodiment, the ink tank 10 has an ink storage capacity of about 700 ml. It is also possible to form a small-capacity ink tank 10 by sharing the tank cover 50 and using a tank casing having a small capacity of about 300 ml.

The tank cover 50 has a connection port 60 to the inkjet printing apparatus 100. The tank cover 50 serves a function of protecting functional portions such as the connection port 60 from an external impact. A side of the tank cover 50 provided with the connection port 60 to the inkjet printing apparatus 100 (a side shown by a broken line; the +Z direction side) is referred to as a first end side 70 (end side) of the tank cover 50. On the other hand, the tank casing 40 side of the tank cover 50 (the opposite side of the first end side 70; the −Z direction side) is also referred to as a second end side 80 (opposite end side). While the tank cover 50 is mounted on the ink tank 10, the first end side 70 (end side) of the tank cover 50 is protruding as compared with the other portion. Thus, for example, in a case where a user mistakenly drops the ink tank 10 and the first end side 70 directly receives an impact, the protruding portion may be chipped or cracked.

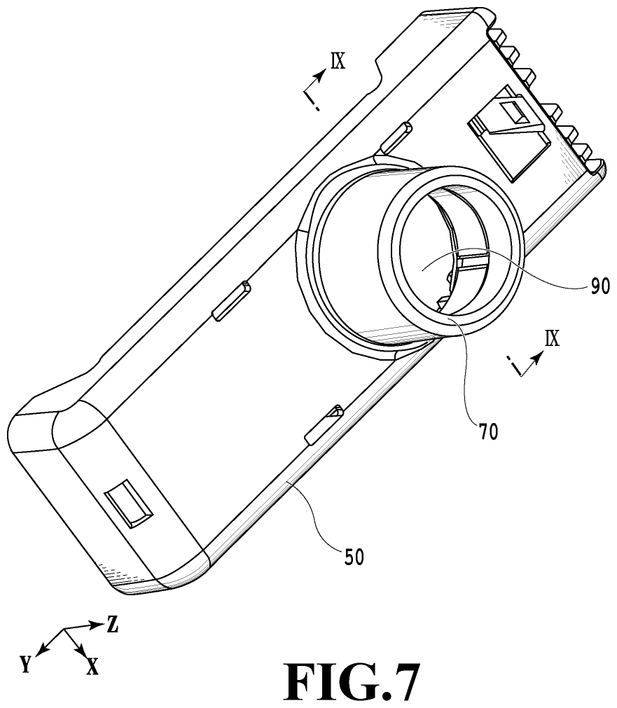

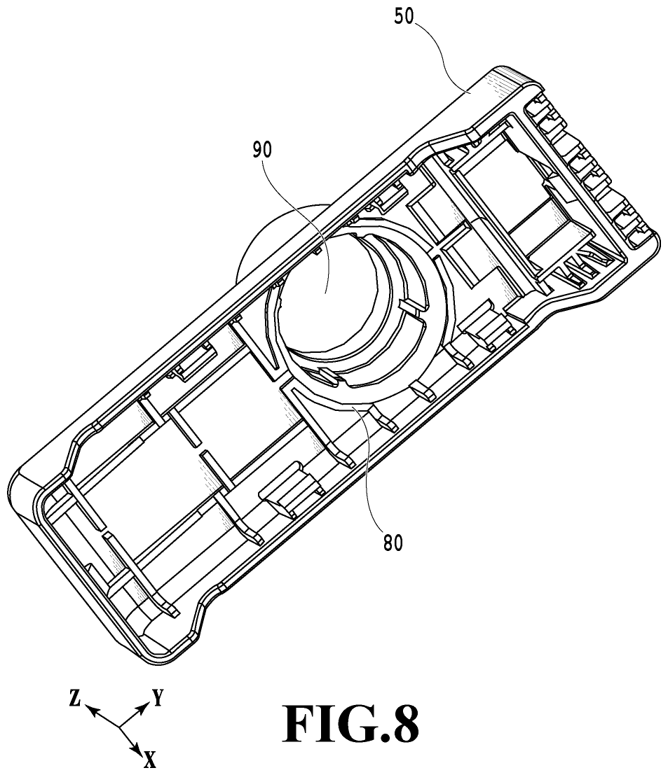

FIGS. 7 and 8 are perspective views of the tank cover 50. FIG. 7 is a perspective view of the entire ink tank 10 seen from the end side (that is, the first end side 70). FIG. 8 is a perspective view seen from the tank casing 40 side (that is, the second end side 80). The tank cover 50 contains a recycled plastic material or a resin material obtained by mixing recycled plastic materials. The tank cover 50 of the present embodiment is formed using a PCR material obtained by recycling a PE material, a PP material, or the like. The tank cover 50 has an opening 90 in which the connection port 60 is provided.

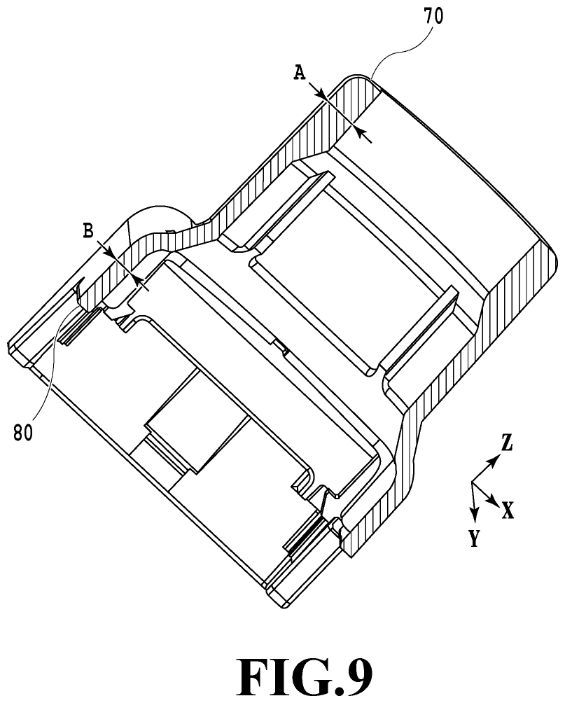

FIG. 9 is a cross-sectional view of the tank cover 50 showing IX cross section in FIG. 7. The IX cross section is a cross section of the tank cover 50 extending across the opening 90 in which the connection port 60 is provided. Further, the IX cross section is a plane intersecting with (orthogonal to) the opening on the first end side 70. In FIG. 9, a side surface width A dimension on the first end side 70 (end side) of the tank cover 50 is about 4.3 mm. On the other hand, a side surface width B dimension on the second end side 80 (opposite end side) is about 2.0 mm. As described above, the protruding portion of the first end side 70 of the tank cover 50 may be chipped or cracked by being dropped. Thus, in the present embodiment, a ratio of the side surface width A dimension on the first end side 70 (end side) to a basic thickness which is the side surface width B dimension on the second end side 80 (opposite end side) is

$$2.15 = A / B .$$

By increasing the width of the A dimension beyond the B dimension which is the basic thickness, chipping or cracking by dropping can be reduced. Incidentally, regarding the side surface width A dimension on the first end side 70 (end side), a back surface of the width on the first end side 70 may have a lightening hole from the viewpoint of reduction of plastic members.

The A/B ratio in the present embodiment can largely increase the impact strength of the tank cover 50. Further, it is known that chipping or cracking by drop/impact can be reduced as long as the PCR material PE has the following physical property values: a Charpy impact value of 4 kJ/m² or more, an MFR value between about 1 g/10 min and about 15 g/10 min inclusive, and a flexural modulus between about 500 MPa and about 1,500 MPa inclusive. It is known that chipping or cracking by drop/impact can be reduced as long as the PCR material PP has the following physical property values: a Charpy impact value of 3 kJ/m² or more, an MFR value between about 30 g/10 min and about 50 g/10 min inclusive, and a flexural modulus of 800 MPa or more.

As described above, also in the present embodiment, high impact strength can be maintained even in a case where the recycled plastic material is used for the liquid storage container. Accordingly, for example, even in a case where the liquid storage container is mistakenly dropped, chipping or cracking can be reduced.

### Third Embodiment

In the third embodiment, an ink tank of a type different from the first embodiment will be described. A recycled plastic material is used also in the ink tank which is a liquid storage container described in the present embodiment.

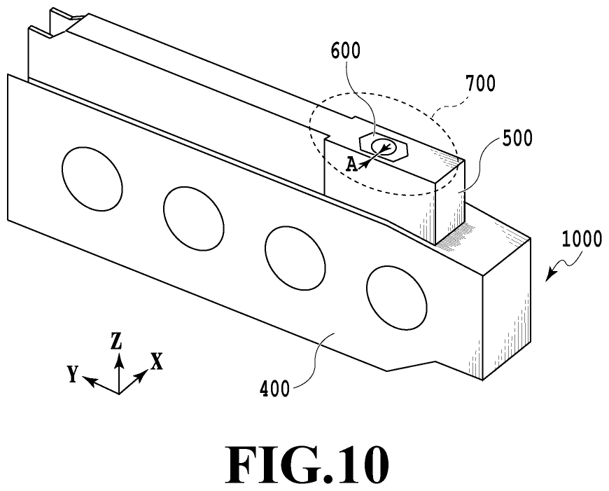

FIG. 10 is a perspective view of an ink tank in the present embodiment. An ink tank 1000 comprises a tank casing 400 and a tank cover 500. The tank cover 500 contains a recycled plastic material or a resin material obtained by mixing recycled plastic materials. The tank cover 500 of the present embodiment is formed using a PCR material obtained by recycling a PE material, a PP material, or the like. The tank casing 400 directly functions as an ink storage unit. In the present embodiment, an ink storage capacity is about 700 ml. The tank cover 500 serves a function of protecting, from an external impact, functional portions such as a connection port 600 to the inkjet printing apparatus 100 provided on the longer side of the tank casing 400. In particular, a first end side 700 (end side) of the tank cover 500 shown by a broken line is protruding as compared with the other portion. Thus, in a case where a user mistakenly drops the ink tank 1000 and the first end side 700 directly receives an impact, the protruding portion may be chipped or cracked.

In the present embodiment, a side surface width A dimension on the first end side (end side) of the tank cover 500 is about 5.0 mm. On the other hand, a side surface width B dimension (not shown) on a second end side (opposite end side) is about 1.0 mm. The protruding portion of the first end side 700 of the tank cover 500 may be chipped or cracked by being dropped. Thus, in the present embodiment, a ratio of the side surface width A dimension on the first end side (end side) to a basic thickness which is the side surface width B dimension on the second end side (opposite end side) is

$$5. = A / B .$$

By increasing the width of the A dimension beyond the basic thickness, chipping or cracking by dropping can be reduced. This A/B ratio can largely increase the impact strength of the tank cover 500.

### Other Embodiments

In the above embodiments, the entire ink tank is configured such that a width dimension on the first end side (end side) on which the tank cover is mounted is greater than the width dimension which is the basic thickness of the second end side (opposite end side) of the tank cover. Incidentally, in a case where a ratio of the width A dimension on the end side to the width B dimension on the opposite end side is equal to or greater than a predetermined value, there is a possibility that the tank cover cannot exercise its primary function. Thus, it is preferable that the ratio of the width A dimension on the first end side (end side) to the basic thickness which is the width B dimension on the second end side (opposite end side) be

$$A / B < 7.$$

Further, as described in the above embodiments, since it is preferable to increase the ratio of the width A dimension of the first end side (end side) to the basic thickness which is the width B dimension of the second end side (opposite end side), it is preferable that

$$1 < A / B < 7.$$

To summarize the above embodiments, it is preferable that the side surface width A of the tank cover on the first end side be between 4.3 mm and 6.0 mm inclusive. In the above embodiments, high impact strength can be maintained even in a case where the recycled plastic material is used for the liquid storage container. Accordingly, for example, even in a case where the liquid storage container is mistakenly dropped, chipping or cracking can be reduced. The use of the recycled plastic material for the liquid storage container can reduce the amount of virgin material in use and therefore has the potential to contribute to the achievement of a sustainable society, such as a decarbonized society/circular society. That is, the technologies described in this specification have the potential to contribute to the achievement of a sustainable society, such as a decarbonized society/circular society.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-206730, filed Dec. 7, 2023, which is hereby incorporated by reference wherein in its entirety.

What is claimed is:

1. A liquid storage container comprising a storage unit configured to store liquid, a supply unit configured to externally supply liquid stored in the storage unit, and a protective member configured to protect the supply unit,
wherein the protective member contains a recycled plastic material or a resin material obtained by mixing recycled plastic materials, and
the protective member has such a portion that while the protective member is attached to the supply unit, a relationship between a side surface width A of the protective member on a first end side and a side surface width B of the protective member on a side of the storage unit opposite to the first end side satisfies
$$1 < A / B < 7.$$

2. The liquid storage container according to claim 1, wherein
the first end side of the protective member comprises an opening in which the supply unit is provided, and
the protective member has such a portion that a relationship between the side surface width A and the side surface width B in a same cross section corresponding to a plane intersecting with the opening satisfies
$$1 < A / B < 7.$$

3. The liquid storage container according to claim 1, wherein the recycled plastic material is a polyethylene material.

4. The liquid storage container according to claim 3, wherein a Charpy impact value of the recycled plastic material is 4 kJ/m² or more.

5. The liquid storage container according to claim 3, wherein an MFR value of the recycled plastic material is between 1 g/10 min and 15 g/10 min inclusive.

6. The liquid storage container according to claim 3, wherein a flexural modulus of the recycled plastic material is between 500 MPa and 1,500 MPa inclusive.

7. The liquid storage container according to claim 1, wherein the recycled plastic material is a polypropylene material.

8. The liquid storage container according to claim 7, wherein a Charpy impact value of the recycled plastic material is 3 kJ/m² or more.

9. The liquid storage container according to claim 7, wherein an MFR value of the recycled plastic material is between 30 g/10 min and 50 g/10 min inclusive.

10. The liquid storage container according to claim 7, wherein a flexural modulus of the recycled plastic material is 800 MPa or more.

11. The liquid storage container according to claim 1, wherein the side surface width A of the protective member on the first end side is between 4.3 mm and 6.0 mm inclusive.

12. The liquid storage container according to claim 1, wherein the recycled plastic material is a post-consumer recycled material.

13. The liquid storage container according to claim 1, wherein the recycled plastic material is a pre-consumer recycled material.
